(19) United States
(12) Patent Application Publication
(10) Pub. No.: US 2016/0100237 A1
(43) Pub. Date: Apr. 7, 2016

(54) Integrated Personal Electronic Device

(71) Applicant: Ben Blouse, Telluride, CO (US)

(72) Inventor: Ben Blouse, Telluride, CO (US)

(21) Appl. No.: 14/862,927

(22) Filed: Sep. 23, 2015

Related U.S. Application Data
(63) Continuation-in-part of application No. 11/469,892, filed on Sep. 4, 2006, now abandoned.
Application No. 11/469,892 is a continuation of application No. 09/642,244, filed on Aug. 16, 2000, now abandoned.
(60) Provisional application No. 60/149,243, filed on Aug. 17, 1999.

(51) Int. Cl. H04R 1/10

(52) U.S. Cl. CPC H04R 1/105; H04R 2420/07

(57) ABSTRACT

An integrated personal electronic device designed to be worn around the back of the head and is supported by resilient elastomeric material which surrounds a ductile wire forming a headband. The headband contains a series of adjustable sinusoidal bends. An electronic signal processor in the form of a small lightweight nodule fits at the back of the head in the occipital region. Earphones are located on either side and at the forward ends of the headband supported by ear surrounds. The ear surrounds fit between the ear and head. The nodule is worn in the occipital region of the head.

This is a continuation-in-part of application Ser. No. 11/469,892 filed Sep. 4, 2006 which was a continuation of application Ser. No. 09/642,244, now abandoned, filed Aug. 16, 2000 which claimed priority to provisional application No. 60/149,243, now expired, filed Aug. 17, 1999. Application Ser. Nos. 11/469,892, 09/642,244 and 60/149,243 are hereby incorporated by reference in their entireties.

### BACKGROUND OF THE INVENTION

### Field of the Invention

The invention relates to integrated electronic personal devices in the form of headsets in which the headband members and main electronic components are rear mounted on the back of a user's head.

### SUMMARY OF THE INVENTION

The integrated personal electronic device according to the present invention comprises a flexible, adjustable, wrap-around headset forming an integrated personal electronic device which fits on the back of a user's head above the neck. My invention is generally comprised of a left headband member comprising a length of elastomeric material surrounding a ductile wire and an electronic signal transmission means. The headband member having a occipital terminus end and an ear terminus end, said left head band member extending along the left temporal region of a user's head generally following along a line extending from the occipital region of said user's head to the ethrnoid region of said head and said left headband member terminating in a region proximal to said user's left ear. My invention further comprises a right headband member comprising a length of elastomeric material surrounding a ductile wire and an electronic signal transmission means, said headband member having a occipital terminus end and an ear terminus end, said right head band member extending along the right temporal region of a user's head generally following along a line extending from the occipital region of said users head to the ethmoid region of said head and said right headband member terminating in a region proximal to said users right ear. An integrated electronic signal processor having left and right ends is connected to the corresponding occipital terminus ends of said left and right headband members. My device also provides means for connecting said processor to said occipital terminus ends of said left and right headband members.

At least one means for converting a signal from said processor into frequencies audible to said user attached to said terminus end of said headband member. This is usually an internal speaker or earphone which is placed in a users ear. These internal speakers frictionally reside in the users auricle and extend into the users internal auditory meatus. Other speaker types may be used such as an external ear covering speaker or a smaller speaker that fits in the middle part of the user′ auricle.

My invention provides means for attaching said converting means to said terminus end of said headband member. These attachments are small audio phono jacks. Other attachments could be used with my invention, such as a USB type connector, fire-wire, or any other suitable connector that is % inch or smaller.

I have also included an electronic signal transmission means for conducting electronic signals between said processor and said converting means. In my preferred embodiment I use conductive metal wire to transmit electric energy throughout my invention. Fiber optic strands are also applicable to this purpose.

The electronic device is contained in a small, lightweight nodule. The headset further comprises a pair of adjustable headband members that spans a distance forward from each side of the nodule along the temporal region of a user's head terminating in an ear support end which substantially surround a user's ear. Controls, earphones, antennae, at least one battery or other power source, and wiring are embedded within the headset. Further embodiments include input and output jacks for communicating with additional media. Examples of such media are MP3 players, WiFi, Blue Tooth, cell phones, compressed digital audio player, satellites, and memory sticks. The embedded parts are not exposed to damage or to snagging on foreign objects or to injuring a user. An ear surround contacts the lower back of the ear, then substantially loops around the ear and curves back in, at the front of the ear, with the attached earphones, on ear side of a user's head. The attached earphones are worn partially within a user's ear, From the ears, trailing back toward the back of the head, the wrap-around headset is further comprised, in the preferred embodiment, of sinusoidal bends that provide both non-slip fit and adjustability. The sinusoidal bends are either compressed or extended by a user to adjust fit of the headset.

The headset flexes in any direction, thereby conforming to the shape of a user's head. When adjusted correctly, the headset fits a user firmly and resists movement such that virtually any activity does not cause the headset to move or bounce.

The headset may be adjusted to fit any size head. Movement of the headset is further resisted because the headset does not rest on a user's neck but it, instead, is held above the neck, at the back of the head. Additionally, the light weight and small size of the headset provides for using a hair clip to further constrain the device. The soft elastomeric material of the headband surrounds the ductile wire, or other appropriate material, such that the headband is non-permanently shaped to fit a user's head and neck. Additionally, the soft elastorneric material provides a frictional interlace with skin or hair, further enhancing position retention. The memory of the ductile material within the headband provides shape retention until changed by a user, Speaker wires are housed within the elastomeric material, along with the ductile element. Speaker wires thereby internally connect the earphones with a nodule at the back of a users head.

The nodule is located centrally between the two earpieces. The nodule is a small, compact, substantially oval-shaped housing, continuous with the elastomeric material of the headset, The integrated electronics are contained within the nodule. Speaker wires emanate from each speaker and terminate within the electronic nodule. The nodule contains the electronic circuitry necessary for function of the personal electronic device.

The nodule may be equipped with jacks for transmitting and receiving. With the nodule located as it is, further comfort and placement retention is provided.

The substantial ear surround of the device fits between the ear and the user's head. As such, the wearing of glasses, goggles, hat, helmet, or other such devices is not negated nor interfered with, thereby providing even greatly utility for the device.

The construction of one embodiment of my invention is seamless, such that it is waterproof for use in any active involvement including rain, swimming activities or the like. As the elastomeric material is both soft and durable, the headset is riot prone to breakage or damage. Dropping abusing, or stepping on the headset is of little concern. This durability feature further ensures the capabilities of the invention in virtually any activity. In one embodiment, the invention includes a remote transmitter. In a further embodiment, a microphone for transmitting is embedded within the invention.

The personal electronic device can be worn with glasses or hat or virtually any type of headgear. The invention includes hair clips which are used to further anchor the headband to hair or headgear.

In yet another embodiment of my invention, the electronic components may be selectively removed for interchangeability with other players, decoders, transceivers, analog processors, digital processors, headphones, earphones, cell phones microphones, digital satellite transceivers or any other miniature electronic processor

### BRIEF DESCRIPTION OF THE DRAWINGS

Attention is now directed to several illustrations that show features of the present invention:

FIG. 1 is a side view of the personal electronic device worn by a user.

FIG. 2 is a side view of an alternate embodiment of the personal electronic device worn by a user.

FIG. 3 is a side view of another alternate embodiment of the personal electronic device worn by a user.

FIG. 4 is a back view of FIG. 3

FIG. 5 is back view of FIG. 3.

FIG. 6 is a back perspective view of an alternative embodiment.

FIG. 7 is a straight back view of the embodiment of FIG. 6.

FIG. 8 is a side view of the embodiment of FIG. 6.

FIG. 9 is a top view of the embodiment of FIG. 6.

The scope of the present invention is not limited to what is shown in the figures.

### DETAILED DESCRIPTION OF THE PREFERRED EMBODIMENT

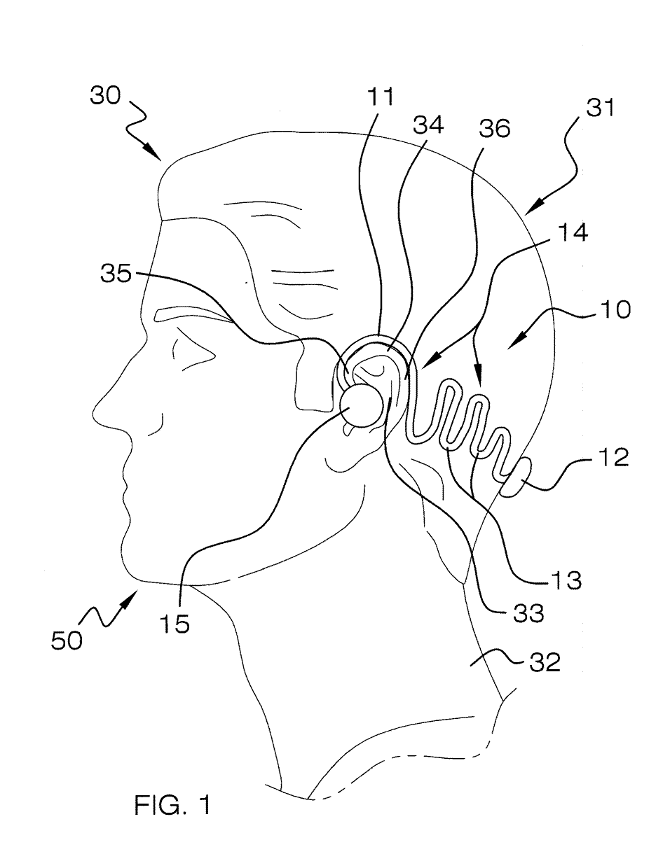

Referring to FIG. 1 the integrated personal electronic device 10 fits at the back of a head 31 of user 50, above neck 32. The device 10 includes earphones 15 located on either side and at the forward ends of headband members 14, which include a right headband member 14a and a left headband member 14b. Speakers 15 removably fit within user's ears 33. Headband 14 further includes an ear surround 11 for each of the right and left headband members 14a, 14b. Ear surround 11 terminates seamlessly at speakers 15. From speakers 15 ear surround 11 loops first forwardly, with respect to ear 33, then begins to loop upwardly around front of ear 35. From thence, ear surround 11 smoothly transitions to loop over top of ear 34, then behind back of ear 36. Ear surround 11 ideally fits between user's ear 33 and head 31. Each of the right and left headband members 14a, 14b has a respective first length and second length of elastomeric material surrounding a ductile wire 18. Posterior to ear surround 11, each of the right and left headband members 14a, 14b then begins a plurality of sinusoidal bends 13 disposed along the respective first and second length that terminates seamlessly into electronic nodule 12. In some embodiments, there is only a partial sinusoidal bend.

The sinusoids 13 are substantially in a vertical plane. Nodule 12 is worn at back of user's head 31 above back of user's neck 32. Nodule 12 is substantially oval-shaped with flat front and back sides. Nodule 12 contains the necessary electronic circuitry for the various functions of device 10. Headband 14 is elastomeric and contains ductile wire (not shown) within. Shape retention and conformation to user's head 31 are thereby temporarily provided until a user 50 changes that shape.

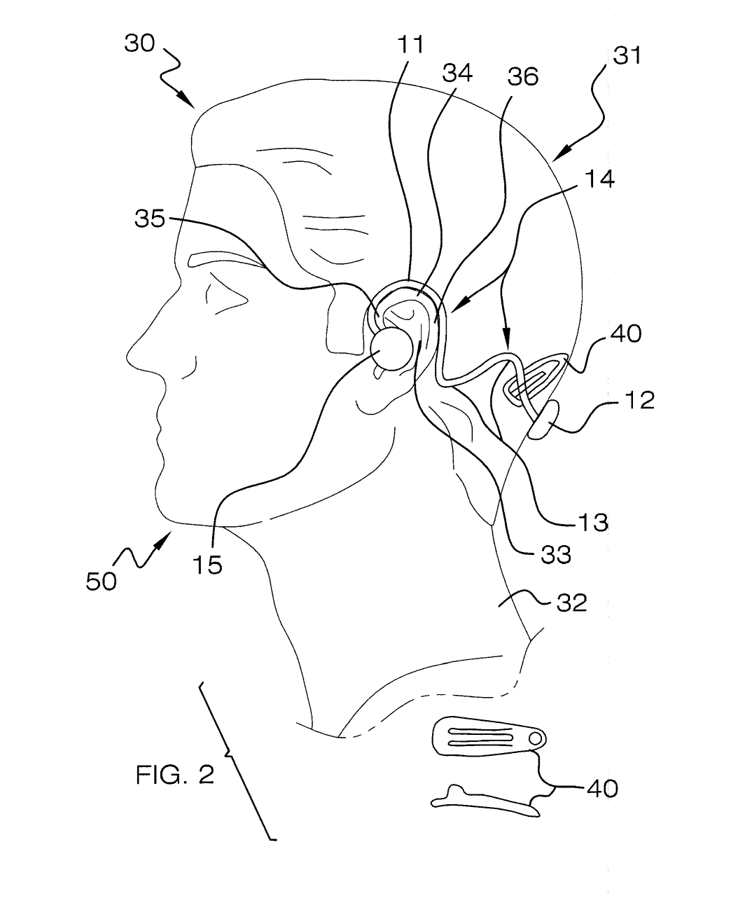

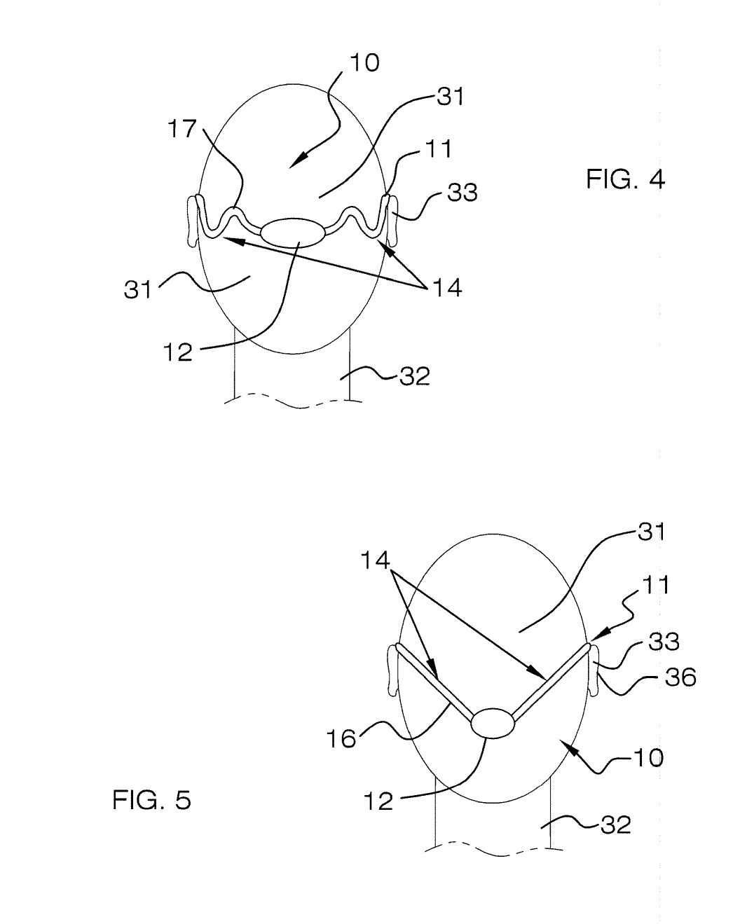

Referring to FIGS. 2 and 4, headband 14 of alternate embodiment of invention 10 is shown. Flexible, shape-retaining headband 14 further comprises ear surrounds 11. The function and appearance of invention 10 remain substantially the same as in FIG. 1. A single sinusoid 17 is shown in FIG. 4. The preferred embodiment, FIG. 1˜discloses a plurality of sinusoidal bends 13. Bends 13 are located about midway between ear surrounds 11 and nodule 12. Nodule 12 is centrally and symmetrically located between earphones 15. Hair clip 40 further anchors headband 14 to the hair of user 30. Hair clip 40 is also used to anchor invention 10 to a hat (not shown), headgear (not shown), or goggle strap (not shown).

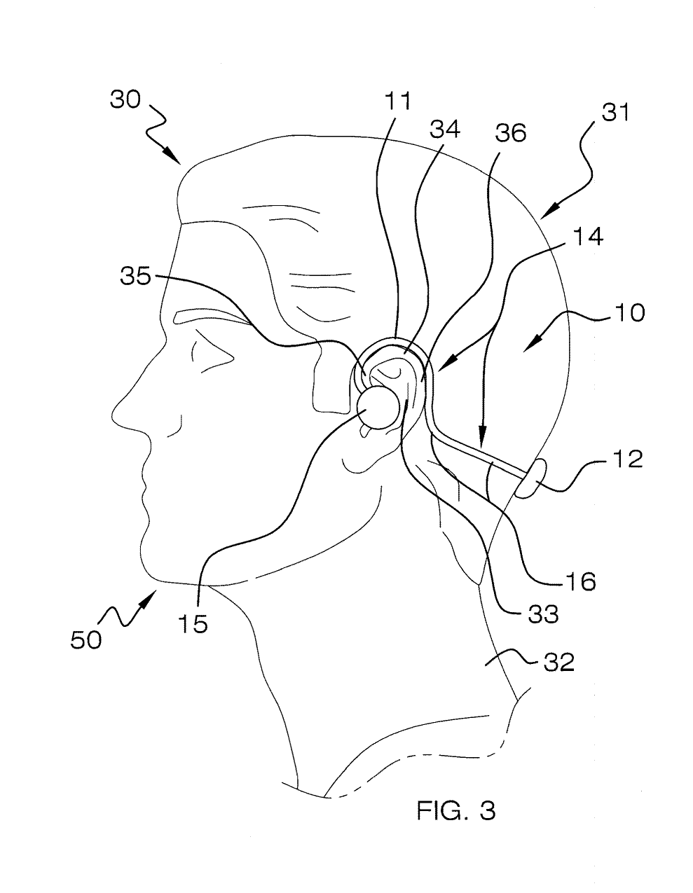

Referring to FIGS. 3 and 5, flexible, memory-retaining substantially straight headband 14 locates nodule 12 at back of user's head 31 and above user's neck 32. Functionality and material structure of device 10 remain, Headband 14 is comprised of ear surrounds 11 which curve backward from back of ear 36 of user's ear 33.

Surrounds 11 from thence smoothly and seamlessly transition into posterior headband members 16. Members 16 seamlessly terminate rearwardly in nodule 12.

In use, in FIG. 1, user 50 flexibly spreads device 10 sufficiently for earphones 15 to fit within user's ear 33. Ear surrounds 11 are looped substantially around ears 33. Sinusoidal bends 13 of headband 14 progress backward to locate nodule 12 at back of user's head 31. User 50 then slightly compresses headband 14 by compressing sinusoidal bends 13 such that memory of headband 14 shape is retained and invention 10 remains snugly in place. Flexibly compressed device 10 thereby conforms to user's head 31. Earphones 15 are placed in user's ears 33, and, when pushed gently inwards, retaining their positions. Ear surrounds 11 loop substantially around user's ear 33 to further insure placement retention. Ear surrounds 11 are flexed to conform to ears 33. Placement retention is further insured by locating nodule 12 to best fit against user's head 31. Hair clip 40 is used to further locate and secure invention 10 to user's hair 30. Removal of device 10 comprises a removal of hair dip 40 and openly flexing device 10.

Referring to use in FIG. 2, user 50 performs the same functions as for the embodiment of FIG. 1 but does so with compression of a single sinusoidal bend 13. Removal is identical to that of the embodiment in FIG. 1.

Referring to FIGS. 3 and 5, a user 50 openly flexes invention 10 to allow insertion of earphones 15 into user's ears 33. Device 10 is then compressed inwardly to conform to user's head 31. User 50 then flexes headband 14 at juncture 16 of ear surrounds 11 and headband member 16. Juncture 16 is flexed forward to further surround ear 33 thereby increasing ear surround 11 drawing nodule 12 snugly against back of user's head 31.

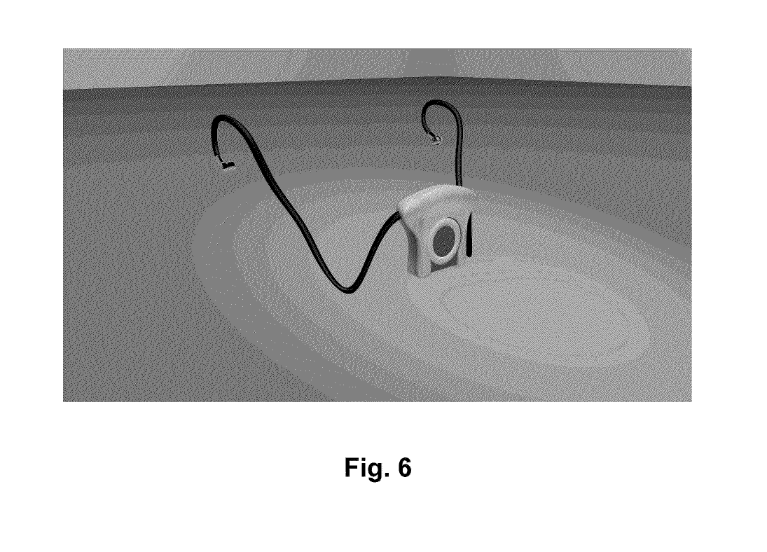

FIG. 6 shows a back perspective view of a alternate embodiment of the present invention. This embodiment has a single part of a sinusoid on each side which loops up to a circular portion that surrounds the ear. The sinusoids give the headphone stand-alone stability with no need for attachment to eyewear, molding to the head and supporting a media device securely in the back. Being flexible, the headphones move with the user and not against the user so they stay on, and do not pull out and off.

This embodiment works with the Apple SHUFFLE™ 4th generation. The invention includes a waterproof BLUETOOTH™ module the same size as the SHUFFLE which, when inserted, makes the headphone a fully functioning Bluetooth headphone. It is also waterproof so a user can swim with it. The earpieces can be interchangeable allowing for the customizing to the users desires.

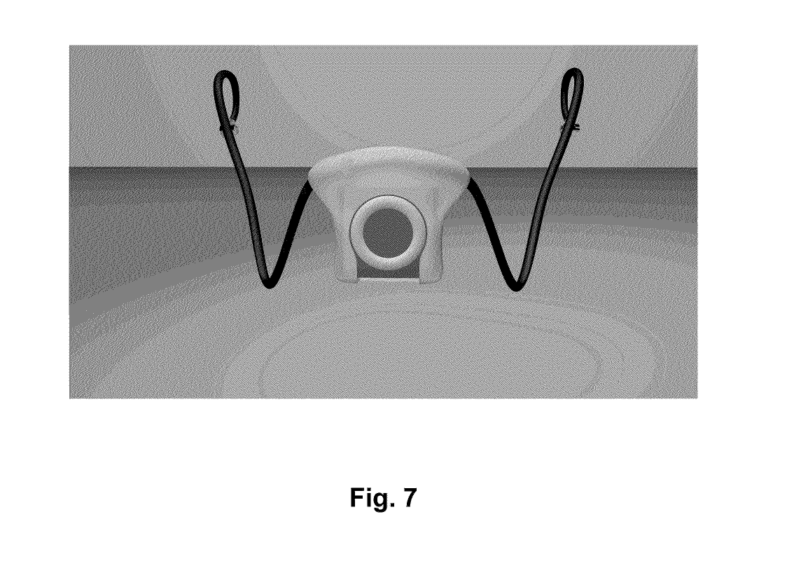

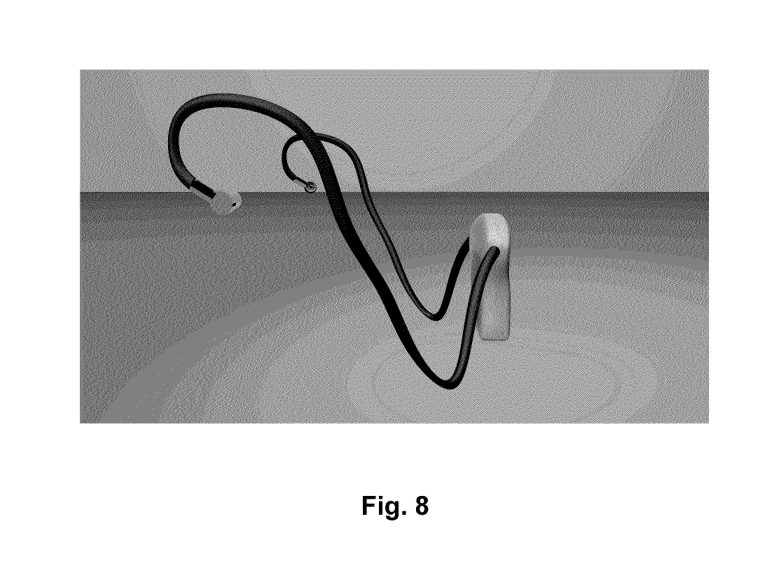

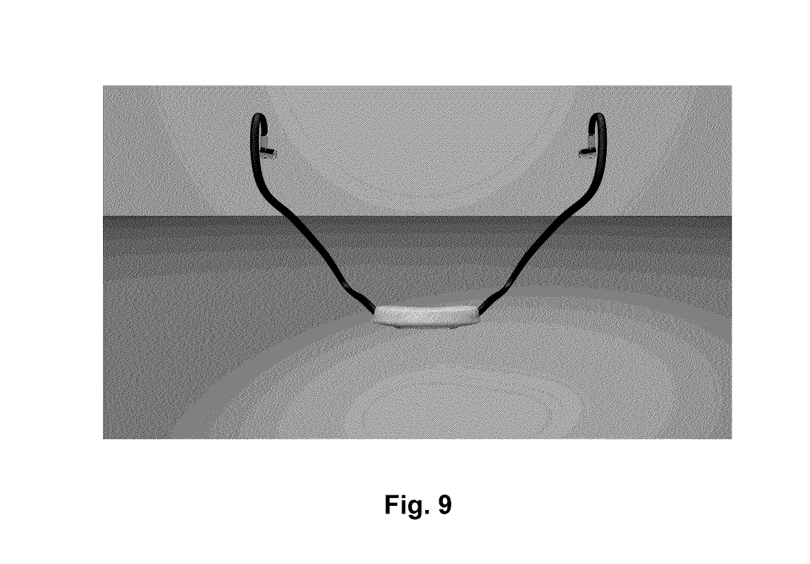

FIG. 7 shows a straight back view of this embodiment, while FIGS. 8-9 shows a side and top view respectively.

Several descriptions and illustrations have been presented to aid in understanding the present invention. One with skill in the art will realize that numerous changes and variations may be made without departing from the spirit of the invention. Each of these changes and variations is within the scope of the present invention.

I claim:

1. An integrated personal electronic device comprising:
a left headband member including a first length of elastomeric material surrounding a first ductile wire, said left headband member shaped into a first plurality of sinusoids disposed along the first length, said first plurality of sinusoids lying in a vertical plane when said device is worn,
a right headband member including a second length of elastomeric material surrounding a second ductile wire, said right headband member shaped into a second plurality of sinusoids disposed along the second length, said second plurality of sinusoids lying in a vertical plane when said device is worn, wherein, said first plurality of sinusoids on the left headband member is symmetrical to said second plurality of sinusoids on the right headband member, and said elastomeric material has shape memory;
said first and second headband members connected together at a point located at a rear center position of said device when the device is worn;
said first and second headband members each attached to an earphone at an unconnected end, each earphone being electrically connected to one of said first or second ductile wire;
each of said first and second headband members terminating in an elastic ear surround loop adapted to be positioned behind a user's ear during deployment and to support said earphone;
a wireless receiver attached to said point where the first headband member is connected to said second headband member, said wireless receiver adapted to supply an audio signal into said first and second ductile wire;
said device being adapted so that a user wearing said device can listen to audio received by said wireless receiver.

2. An integrated personal electronic device comprising:
a left headband member comprising a length of elastomeric material having shape memory surrounding a ductile wire, a partial sinusoid disposed along the length, said left headband member having an occipital terminus end and an ear terminus end;
a right headband member comprising a length of elastomeric material surrounding a ductile wire, a partial sinusoid disposed along the length, and an electronic signal transmission means, said right headband member having an occipital terminus end and an ear terminus end;
a short-range radio transceiver having left and right ends connected to the corresponding occipital terminus ends of said left and right headband members;
at least one speaker at each terminus end for converting a signal from said radio transceiver into frequencies audible to a user, said speaker attached to said ear terminus end of said headband member,
an electric conductor in each of said headband members configured to conduct electronic signals between said processor and said speaker:
and each of said ear terminus ends forming an ear surround loop adapted to be placed behind a wearer's ears to support.

3. The device of claim 2 wherein said occipital terminus of said headband members is configured to be seamlessly integrated into said left and right ends of said short-range radio transceiver ear terminus ends seamlessly integrated with said speaker; and wherein the integrated personal electronic device is configured to create waterproof connections between said electronic signal processor, said speakers and said right and left headband members.

4. An integrated personal electronic earphone device of the type with left and right earphones attached to symmetrical left and right band where the bands are left and right connected to a wireless receiver, the wireless receiver adapted to make contact with the back, center of a user's head when the device is worn, the device comprising:
symmetrical left and right bands of substantially circular cross-section each containing a least one electrical cable connecting one of the earphones with the wireless receiver, the bands being of elastic material having memory that regains an original shape upon being deformed;
each of the bands separately having a first approximately straight region adjacent said wireless receiver, a second sinusoidal region adjacent the approximately straight region, and an ear surround loop adapted to loop over a user's ears adjacent to the sinusoidal region terminating in one of said earphones and to support said earphone;
wherein, in said sinusoidal region, the left and right bands are shaped to form one or more sinusoids, the sinusoids being adapted to stretch to fit and to lie vertically along a user's head when the device is worn;
wherein, said bands are configured to conform to a user's head and elastically hold said earphones in the user's ears;
whereby, wireless signals containing audio content received by the wireless receiver provide audio electrical signals to the earphones allowing the user to hear sound.

5. The device of claim 4 further comprising at least one port on said wireless device adapted for wire connection to a separate sound source.

6. The device of claim 4 wherein said wireless receiver receives a radio signal.

7. The device of claim 4 wherein said radio signal is BLUETOOTH.
